(19) United States
(12) Patent Application Publication
(10) Pub. No.: US 2023/0074635 A1
(43) Pub. Date: Mar. 9, 2023

(54) AIR CONDITIONING APPARATUS FOR VEHICLE

(71) Applicants: HYUNDAI MOTOR COMPANY, Seoul (KR); KIA CORPORATION, Seoul (KR)

(72) Inventor: Nam Seok YUN, Hwaseong-si (KR)

(73) Assignees: HYUNDAI MOTOR COMPANY, Seoul (KR); KIA CORPORATION, Seoul (KR)

(21) Appl. No.: 17/574,040

(22) Filed: Jan. 12, 2022

(30) Foreign Application Priority Data
Sep. 7, 2021 (KR) 10-2021-0118953

(51) Int. Cl. B60H 1/00

(52) U.S. Cl. CPC B60H 1/00564; B60H 1/00371

(57) ABSTRACT

An air conditioning apparatus for a vehicle includes an air conditioner unit disposed in an air conditioning room of a vehicle and configured in such a manner that ambient air, introduced into the air conditioning room from an outside of the vehicle, is suctioned and blown to an interior of the vehicle by a blower; a damper installed in an opening on an introduction side of the air conditioner unit to selectively allow introduction of one of indoor air flowing from the interior and ambient air; and an internal exhaust grill installed in the interior to fluidly communicate with a space defined by the air conditioner unit and an internal side surface of the air conditioning room, wherein the indoor air in the interior may be discharged to an outside of the vehicle through the internal exhaust grill and the air conditioning room.

### CROSS-REFERENCE TO RELATED APPLICATION

The present application is based on and claims the benefit of priority to Korean Patent Application No. 10-2021-0118953, filed on Sep. 7, 2021 with the Korean Intellectual Property Office, the entire disclosure of which is incorporated herein by reference.

### TECHNICAL FIELD

The present disclosure relates to an air conditioning apparatus for a vehicle having a two-story structure, such as a double-decker bus, or the like. For example, the air conditioning apparatus may forcibly ventilate at least an upper-story interior of a vehicle.

### BACKGROUND

Double-decker buses with seats on upper and lower stories are ubiquitous. A double-decker bus may accommodate a larger number of passengers because a capacity of the double-decker bus is increased by at least 1.5 times, as compared with a single-decker bus. In addition, since a double-decker bus has a driver's seat on a lower story, a seat maybe mounted in a front row of an upper story and a front view having almost no obstructions may be provided.

However, such a large-sized double-decker bus has a significantly larger interior space and a significantly larger number of seats than a general single-decker bus. Therefore, both a size and a capacity of an air conditioning apparatus should be increased, so that it may be difficult to configure and locate an air conditioning apparatus.

Moreover, a forced ventilation apparatus using a blower is not applied to a conventional double-decker bus, and thus, ambient air may not be automatically introduced into an upper story. Since ventilation may be performed by manually opening a window according to intention of a passenger in an upper story, ventilation timing may not be controlled and cooling or heating efficiency of an interior may be deteriorated. In addition, when a window is manually opened, ambient air does not pass through a dust collecting filter, so that pollutants such as fine dust, and the like, may be introduced into the interior.

### SUMMARY

An aspect of the present disclosure is to provide an air conditioning apparatus for a vehicle which may forcibly ventilate at least an upper-story interior in a vehicle having a two-story structure, such as a double-decker bus.

According to an aspect of the present disclose, an air conditioning apparatus for a vehicle includes an air conditioner unit to be disposed in an air conditioning room of a vehicle, the air conditioner unit including a blower to suction and blow ambient air to an interior of the vehicle, wherein the ambient air is air that is introduced into the air conditioning room from an outside of the vehicle; a damper installed in an opening on an introduction side of the air conditioner unit to selectively allow the introduction of one of indoor air flowing from the interior and the ambient air; and an internal exhaust grill to be installed in the interior to fluidly communicate with a space defined by the air conditioner unit and an internal side surface of the air conditioning room. The indoor air may be discharged to an outside of the vehicle through the internal exhaust grill and the air conditioning room.

In an embodiment, the air conditioning apparatus may further include: an introduction grill in a body shell of the vehicle to allow an inside of the air conditioning room and the ambient air to fluidly communicate with each other; and a discharge grill spaced apart from the introduction grill in the body shell to allow the inside of the air conditioning room and the ambient air to fluidly communicate with each other.

In an embodiment, the air conditioning room may include: a partition member to connect opposite internal walls of the interior, the partition member having: (i) one side edge to connect to a rear end portion of a deck of the vehicle, and (ii) at least one internal circulation grill and the internal exhaust grill, adjacent to opposite ends of the partition member, may be installed in the partition member; an upper panel to connect the other side edge of the partition member and a rear surface of the body shell to each other.

In an embodiment, the at least one internal circulation grill and the internal exhaust grill may be exposed to the interior below a rearmost seat placed on the deck.

In an embodiment, the air conditioner unit may include a main body including an upper stage in a form of a duct and a lower stage in a form of a frame, and the damper may be disposed in the upper stage.

In an embodiment, the air conditioning apparatus may further include a guide duct and at least one exhaust port, where the at least one exhaust port is to be opened toward the air conditioning room and may be formed in an upper surface of the upper stage. The at least one exhaust port may be connected to the guide duct, and the guide duct may be connected to a duct provided in the interior.

In an embodiment, the air conditioning apparatus may further include a dust collecting filter, an evaporator, a compressor, and a condenser module for a refrigerant of the evaporator, where the dust collecting filter, the evaporator, and the blower may be sequentially disposed from a front surface in the upper stage. The compressor and the condenser module may be mounted in the lower stage.

In an embodiment, the air conditioner unit may further include a main body including an upper stage in a form of a duct and a lower stage in a form of a frame. The upper stage may include: at least one first suction port on a front surface of an upper stage and fluidly communicating with the at least one internal circulation grill to introduce the indoor air from the interior thereinto; and at least one second suction port in an upper surface of the upper stage to introduce ambient air thereinto. The damper may be installed between the first suction port and the second suction port.

In an embodiment, the damper may include: a mounting bracket coupled to the main body; a door rotatably installed on the mounting bracket via a door shaft; and an actuator installed on the mounting bracket and connected to the door shaft to transmit rotational driving force to the door.

In an embodiment, the air conditioning apparatus may further include: a concentration sensor installed in the interior or the air conditioner unit to detect a concentration of pollutants in the indoor air; and a control unit configured to selectively control operations of the damper and the blower according to a detection signal input from the concentration sensor.

In an embodiment, the air conditioning apparatus may further include an input unit electrically connected to the control unit. The input unit may receive an input signal based on driver's manipulation, motion, or voice.

In an embodiment, when in an outdoor air mode, the door shaft may be rotated by the actuator to rotate the door, and the first suction port may be closed by the door and the second suction port may be opened by the door and, at the same time, the blower may operate such that the ambient air is forcibly introduced into the air conditioner unit and the interior.

In an embodiment, when in an indoor air mode, the door shaft may be rotated by the actuator to rotate the door, and the second suction port may be closed by the door and the first suction port may be opened by the door, and indoor air in the interior may be introduced into the air conditioner unit through the at least one internal circulation grill.

According to another aspect of the present disclose, a method includes ventilating the interior of the vehicle via the air conditioning apparatus of claim 1.

In an embodiment, the vehicle may have a two-story structure.

In an embodiment, the vehicle may be a bus.

In an embodiment, the vehicle maybe a railway vehicle.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a perspective view illustrating a vehicle having a two-story structure to which an air conditioning apparatus according to an example embodiment of the present disclosure is applied.

FIG. 2 is a perspective view illustrating a portion of the vehicle illustrated in FIG. 1.

FIG. 3 is a perspective view illustrating the air conditioner unit illustrated in FIG. 2 in an indoor air mode.

FIG. 4 is a perspective view illustrating the air conditioner unit illustrated in FIG. 2 in an outdoor air mode.

FIG. 5 is a perspective view illustrating a damper installed on an air conditioner unit.

FIG. 6 is a cross-sectional view illustrating a portion of an air conditioner unit when an air conditioning apparatus for a vehicle according to an example embodiment of the present disclosure is in an indoor air mode.

FIG. 7 is a cross-sectional view illustrating a portion of an air conditioner unit when an air conditioning apparatus for a vehicle according to an example embodiment of the present disclosure is in an outdoor air mode.

FIG. 8 is a schematic diagram illustrating a control relationship of an air conditioning apparatus for a vehicle according to an example embodiment of the present disclosure.

### DETAILED DESCRIPTION

Hereinafter, the present disclosure will be described in detail with reference to example drawings. In adding reference numerals to components of each of the drawings, it should be noted that the same components are given the same reference numerals as possible even when they are indicated on different drawings.

The term used herein “vehicle” refers to various types of vehicle for transporting a human or an animal, an object, or the like, from an origin to a destination. Such a vehicle is not limited to vehicles travelling on a road or a track.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

In addition, the terms “front,” “rear,” “left,” “right,” “right and left,” “upper,” “lower,” “upper and lower,” and the like, used in relation to the direction are defined based on a vehicle or a vehicle body.

For ease of description, a description will be mainly provided for an example embodiment in which an air conditioning apparatus according to the present disclosure is applied to a double-decker bus having an upper story and a lower story, but application examples are not limited thereto and may be applied to any vehicle having a double-story structure, such as a railway vehicle.

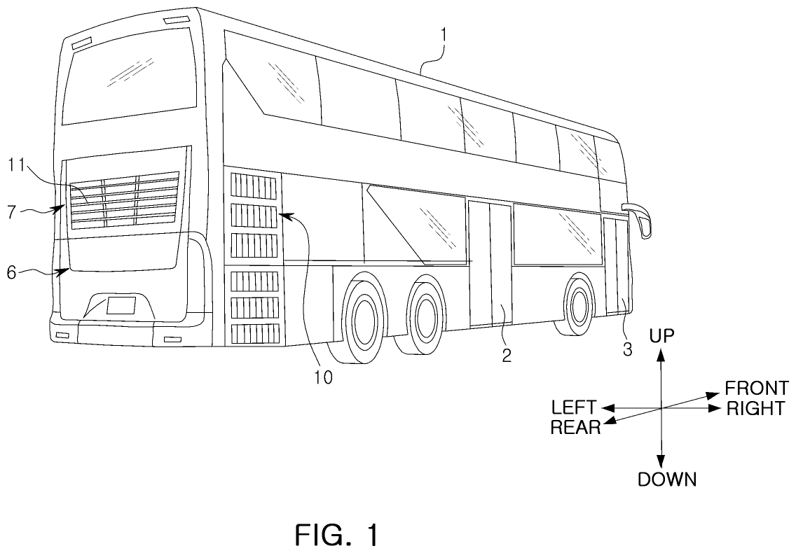

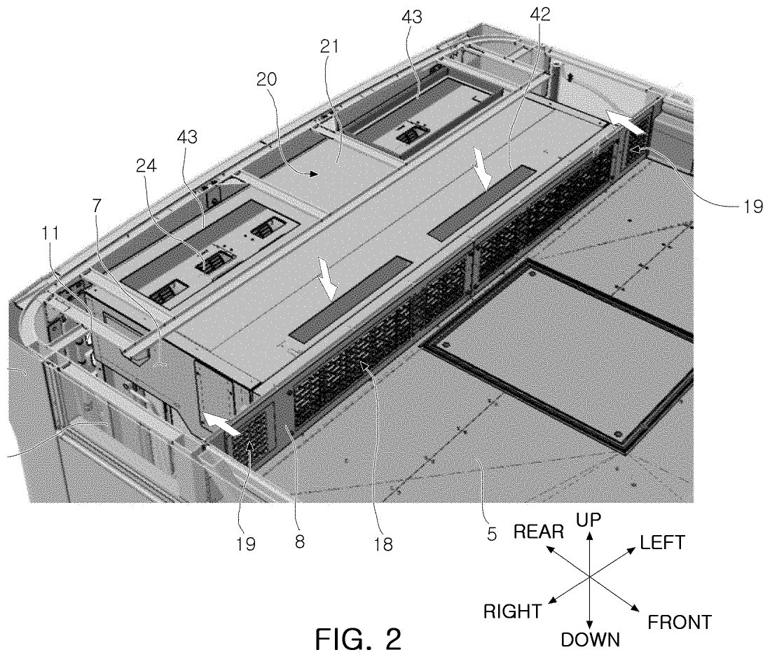

As illustrated in FIG. 1, a vehicle 1 may have a rear door 2 on one side surface of a body shell, and may be provided with a staircase installed therein. The staircase may be adjacent to the rear door 2 and may extend and be inclined to vertically connect a lower deck and an upper deck 5 (see FIG. 2) in a vehicle having a two-story structure. In addition, a front door 3 may be provided on one side surface in the front of a direction in which the vehicle having a two-story structure travels.

For example, a passenger riding through the front door 3 or the rear door 2 may sit on a seat mounted on the lower deck of an interior, or may ascend the staircase and sit on a seat mounted on the upper deck 5. In the drawings including FIG. 1, seats are not illustrated.

In addition, an engine room 6 may be partitioned in the rear of a lower story of the vehicle 1, and an engine or a driving motor (not illustrated) may be mounted in the engine room. An air conditioning room 7 may be partitioned on the engine room across the upper and lower stories of the vehicle having a two-story structure, and an air conditioner unit 20 (see FIG. 2) of the air conditioning apparatus for a vehicle according to an example embodiment may be disposed in the air conditioning room.

As described above, since the engine room 6 is disposed in the rear of the vehicle 1, seats of the lower story may be disposed, in detail, in the front and the middle of the vehicle having a two-story structure, and the seats of the upper story may be provided over almost a full length of the vehicle having a two-story structure. For this reason, components, other than the seats, needs to be integrally placed in the rear of the staircase.

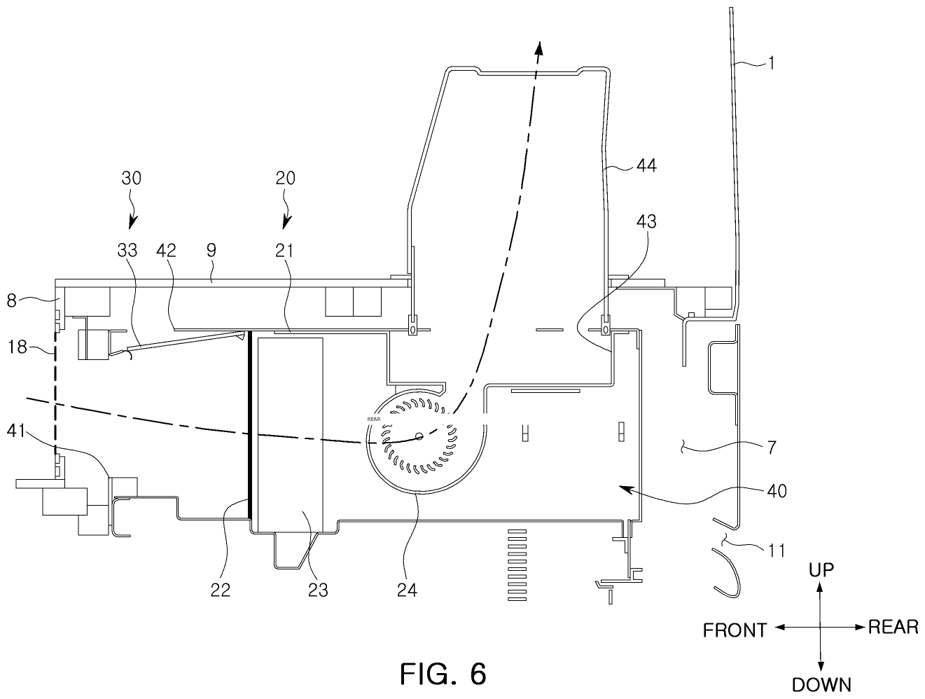

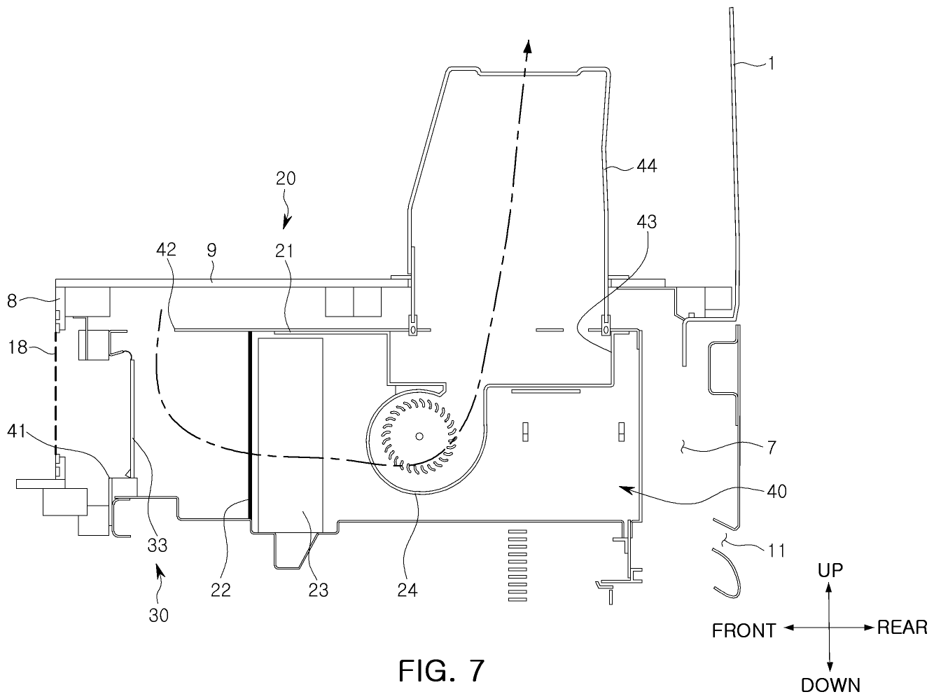

As illustrated in FIG. 2, the air conditioning room 7 may be partitioned by a partition member 8 installed to connect an edge of one side thereof to a rear end portion of the upper deck 5 and to stand upright to connect opposite internal walls of an upper interior of the vehicle 1, a rear surface and opposite side surfaces of the body shell of the vehicle having a two-story structure, an upper panel 9 (see FIGS. 6 and 7) connecting an edge of the other side of the partition member 8 and the rear surface of the body shell, and an upper surface or a frame of the engine room 6.

Optionally, a rearmost seat placed on the upper deck 5 of the vehicle 1 may be installed on an upper panel 9. To this end, the upper panel 9 may be formed of an insulating material or may be insulated.

In addition, a plurality of internal grills (for example, 18 and 19) may be installed on the partition member 8. At least three internal grills may be arranged in series to be disposed in a length direction of the partition member (a width direction of the vehicle). For example, the plurality of internal grills may include at least one internal circulation grill 18 disposed in the center of the partition member 8 in the length direction, and an internal exhaust grill 19 adjacent to opposite ends of the partition member 8 in the length direction.

The plurality of internal grills (for example, 18 and 19), installed on the partition member 8, may be exposed to an upper interior from a lower portion of the rearmost seat placed on the upper deck 5 of the vehicle 1.

The internal circulation grill 18 may fluidly communicate with a first suction port 41, to be described later, of the air conditioner unit 20. The internal exhaust grill 19 may allow a space, defined by the air conditioner unit 20 and an internal side surface of an air conditioning room 7, to fluidly communicate with the upper interior.

The air conditioning room 7 may also fluidly communicate with ambient air of the vehicle 1 through an introduction grill 10 and a discharge grill 11.

Returning to FIG. 1, the introduction grill 10 may be provided to supply fresh ambient air to the engine room 6 and the air conditioning room 7, and may be formed on at least one of the opposite rear side surfaces of the body shell of the vehicle 1 to allow at least an inside of the air conditioning room 7 to fluidly communicate with ambient air. Accordingly, the air conditioner unit 20 may be disposed to be close to, in detail, the introduction grill 10 in the air conditioning room 7 to efficiently suction the ambient air through the introduction grill 10.

The discharge grill 11 may be formed on a rear surface to be spaced apart from the introduction grill 10 in the body shell of the vehicle having a two-story structure such that air in the vehicle 1 may be discharged outwardly. The discharge grill 11 may allow ambient air and at least the inside of the air conditioning room 7 among the engine room 6 and the air conditioning room 7 to fluidly communicate with each other.

However, a position of the discharge grill 11 is not limited to the above-described example. For example, the discharge grill 11 may be formed on opposite rear side surfaces of the body shell to be spaced apart from the introduction grill 10 upward and downward or forward and backward.

As will be described later, air cooling a condenser module 53 or stuffy air in the upper interior may be discharged outwardly of the vehicle 1 through the discharge grill 11. Accordingly, the air conditioner unit 20 may be disposed to be close to, in detail, a rear surface of the body shell or the discharge grill 11 in the air conditioning room 7 to efficiently discharge air through the discharge grill 11.

The air conditioning apparatus for a vehicle according to an example embodiment may include an air conditioner unit 20 and a damper 30, in addition to the above-described internal exhaust grill 19.

As illustrated in FIGS. 2 to 7, the air conditioner unit 20 may include a main body 21, a dust collecting filter 22, an evaporator 23, a blower 24, a plurality of compressors 51 and 52, and a condenser module 53.

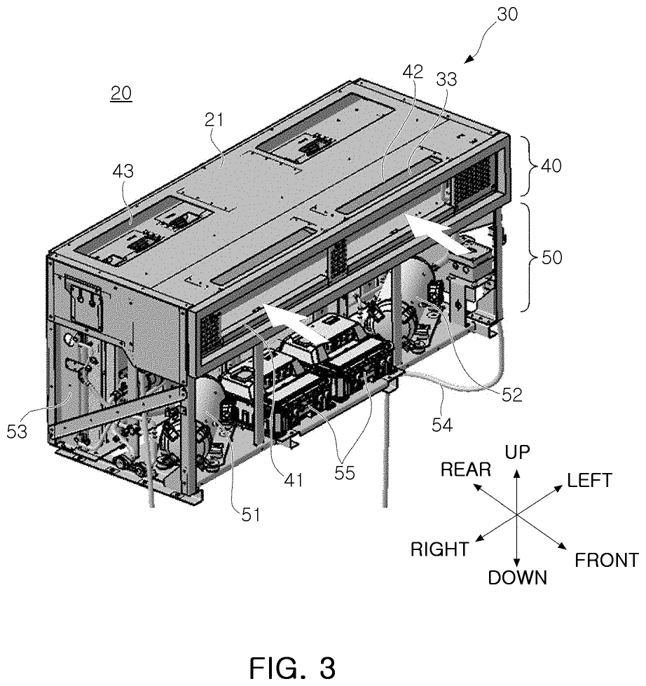

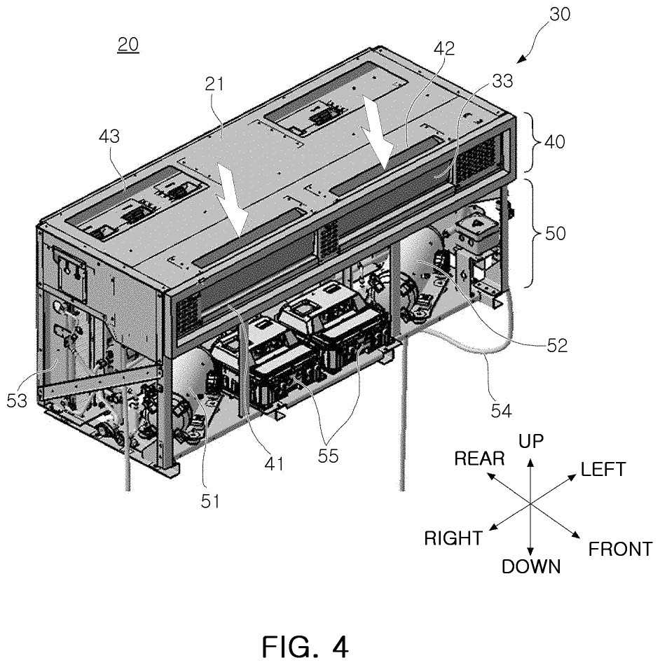

The main body 21 may be formed to have an overall hexahedral shape. As illustrated more clearly in FIGS. 3 and 4, the main body 21 may include two stages, for example, an upper stage 40 and a lower stage 50.

The upper stage 40 of the main body 21 may be formed in the form of a duct having one side and the other side open. The dust collecting filter 22, the evaporator 23, and the blower 24 may be sequentially disposed from a front surface of the upper stage 40.

At least one first suction port 41, opened toward an upper interior of the interior of the vehicle 1, may be formed on the front surface of the upper stage 40 of the main body 21. The first suction port 41 may be formed and disposed to fluidly communicate with the internal circulation grill 18, among a plurality of internal grills installed in the partition member 8. Through the first suction port 41, air in the upper interior circulated by the blower 24 or cooled by the evaporator 23, for example, indoor air, may be suctioned into the upper stage of the main body 21.

At least one second suction port 42, opened toward the air conditioning room 7 of the vehicle 1, may be formed on one side of the upper surface of the upper stage 40 of the main body 21. The second suction port 42 may be disposed to be adjacent to the first suction port 41. Through the second suction port 42, air in the air conditioning room circulated by the blower 24 or cooled by the evaporator 23, for example, ambient air, may be suctioned into the upper stage 40 of the main body 21. The air in the air conditioning room may be supplied from fresh ambient air by the introduction grill 10 of the vehicle having a two-story structure, as described above.

Thus, the first suction port 41 and the second suction port 42 may constitute an opening on an introduction side of the air conditioner unit 20.

In addition, at least one exhaust port 43, opened toward the air conditioning room 7 of the vehicle 1, may be formed on the other side of the upper surface of the upper stage 40 of the main body 21. Thus, the exhaust port 43 may constitute an opening on a discharge side of the air conditioner unit 20.

The exhaust port 43 may be connected to a guide duct 44 (see FIGS. 6 and 7). The guide duct may be directly connected to a duct (not illustrated) provided on a ceiling of the upper interior. The duct of the upper interior may include side ducts provided on left and right sides of the ceiling, but example embodiments are not limited thereto. For example, the duct may include a center duct provided in the center of the ceiling.

The above-configured main body 21 of the air conditioner unit 20 may be spaced apart from the rear surface and opposite side surfaces of the body shell by a predetermined distance in the air conditioning room 7. Accordingly, a space between the main body 21 and the rear surface of the body shell and a space between the main body 21 and the opposite side surfaces of the body shell may form an air flow path.

In addition, the main body 21 may be spaced apart from an upper panel 9 of the air conditioning room 7 by a predetermined distance. Accordingly, a space between the main body 21 and the upper panel 9 may form an air flow path.

The dust collecting filter 22 may be provided to prevent indoor air, containing pollutants such as dust attached to a floor or a seat in the upper interior, or ambient air, containing pollutants such as fine dust, from entering the blower 24, and may be disposed upstream of the evaporator in the upper stage 40 of the main body 21.

For example, the indoor air in the upper interior may be introduced into the first suction port 41, disposed in the upper stage 40 of the main body 21 of the air conditioner unit 20, through the internal circulating grill 18 of the partition member 8, may pass through the dust collecting filter 22 to eliminate the pollutants, and may then be sent to the evaporator 23 and the blower 24.

Alternatively, ambient air outside the vehicle 1 may be introduced into the air conditioning room 7 through the introduction grill 10, maybe introduced into the second suction port 42, disposed in the upper stage 40 of the main body 41, through the space between the main body 21 and the upper panel 9, may pass through the dust collecting filter 22 to eliminate the pollutants, and may then be sent to the evaporator 23 and the blower 24.

The evaporator 23 maybe installed on the air flow path formed in the upper stage 40 of the main body 21, and a refrigerant inlet pipe and a refrigerant outlet pipe (not illustrated) maybe connected to the evaporator. A refrigerant, flowing through the evaporator 23, and the air, passing through the evaporator 23, may exchange heat with each other, so that the evaporator 23 may cool the air, for example, the indoor air or the ambient air.

The refrigerant outlet pipe, connected to the evaporator 23, maybe connected to a first compressor 51. When the first compressor does not operate, the air may pass through the evaporator 23 without heat exchange.

The blower 24 may be disposed between the evaporator 23 and the exhaust port 43 in the upper stage 40 of the main body 21 to send air, simply passing the evaporator 23, or air, cooled by the evaporator 23 while passing through the evaporator 23, to the guide duct 44.

The blower 24 may be provided in plural. The plurality of blowers 24 may be arranged at regular intervals along a length direction of the main body 21 (the width direction of the vehicle). The blower 24 may include an axial fan driven by a motor (not illustrated).

The blower 24 may suction air through the opening on an introduction side of the air conditioner unit 20, and may discharge the suctioned air into the guide duct 44 from the exhaust port 43 of the air conditioner unit 20. Accordingly, in the air conditioning apparatus for a vehicle according to an example embodiment, the blower 24 of the air conditioner unit 20 may act as a suction device allowing indoor air in the upper interior to be introduced into the first suction port 41 or allowing ambient air introduced into the air conditioning room 7 to be introduced into the second suction port 42.

The lower stage 50 of the main body 21 may be formed in the form of a frame having one side closed, for example, a bottom surface closed. The plurality of compressors 51 and 52 and the condenser module 53 may be mounted and supported on the bottom surface.

The plurality of compressors 51 and 52 may include a first compressor 51 and a second compressor 52. The refrigerant outlet pipe, connected to the evaporator 23, may be connected to the first compressor 51. The first compressor 51 may apply a high pressure to a refrigerant, introduced after heat exchange in the evaporator 23, to prepare a high-pressure refrigerant. The first compressor 51 may be driven by an engine or an additional motor, and a refrigerant maybe circulated when the first compressor 51 operates.

A refrigerant pipe 54, connected to an evaporator (not illustrated) in a duct provided in the lower interior, may be connected to the second compressor 52. Similarly, the second compressor 54 may apply a high pressure to a refrigerant, introduced after heat exchange in the evaporator in the duct, to prepare a high-pressure refrigerant.

A reference numeral 55 represents an inverter which may control a speed of a motor when the plurality of compressors 51 and 52 are driven by the motor.

The condenser module 53 may be a module into which a condenser condensing the refrigerant compressed by the first compressor 51, a condenser condensing the refrigerant compressed by the second compressor 52, and a plurality of cooling blowers for cooling these condensers by ambient air are integrated. The cooling blower may include a propeller-type fan driven by a motor.

For example, when the cooling blowers operate, ambient air may be introduced into the air conditioning room 7 through the introduction grill 10 formed on the rear side surface of the vehicle 1. The introduced ambient air may be suctioned into the condenser module 53 to cool a plurality of condensers, and may then be discharged outwardly of the vehicle having a two-story structure through the discharge grill 11 of the vehicle.

A plurality of expansion valves (not illustrated), decompressing and expanding the refrigerant passing through the condenser module 26, may be disposed in the main body 21. One of the plurality of expansion valves may be connected to a refrigerant inlet pipe connected to the evaporator 23.

In the air conditioning apparatus for a vehicle according to an example embodiment, the indoor air in the upper interior of the vehicle 1 maybe circulated to the upper interior of the vehicle 1 via a portion of the air conditioner unit 20, for example, the upper stage 40 of the main body 21, the guide duct 44 and a duct in the upper interior, and the cooling refrigerant may also be circulated through the evaporator 23 in the air conditioner unit 20, the first compressor 51, the condenser module 53, and the like.

On the other hand, the indoor air in the lower interior of the vehicle 1 may be mixed with the indoor air in the upper interior through a staircase, but the indoor air in the lower interior may be circulated in the lower interior through an additional independent circulation path or may cool the lower interior.

The indoor air in the lower interior may be allowed to flow by a blower installed in a duct, serving as a flow path of cold air in the lower interior. A suction port, through which indoor air is introduced into, for example, a side surface adjacent to a vehicle window, may be formed in the duct in the lower interior.

In the case of cooling, the indoor air introduced into the duct in the lower interior may be heat-exchanged to be in a low-temperature state while passing through the evaporator in the duct, and may then be blown by the blower in the duct and discharged from the duct in the lower interior.

However, the refrigerant which has passed through the evaporator in the duct in the lower interior may pass through the second compressor 52 and the condenser module 53 disposed in the air conditioner unit 20 through the refrigerant pipe 54, and may then be circulated again to the evaporator in the duct.

In the air conditioning apparatus for a vehicle according to an example embodiment, when the ambient air introduced from the outside of the vehicle 1 is introduced into the upper interior through a portion of the air conditioner unit 20, for example, the upper stage 40 of the main body 21, the guide duct 44 and the duct in the upper interior, the ambient air may be mixed with the indoor air in the lower interior through the staircase. Accordingly, not only an upper interior but also an lower interior of the vehicle having a two-story structure may be ventilated.

The damper 30 may be installed in an opening on an introduction side of an upper end potion of the air conditioner unit 20. For example, the damper 30 may installed between the first suction port 41 formed on the front surface of the upper stage 40 of the main body 21, and the second suction port 42 formed on one side of an upper surface 40 of the main body 21 to selectively allow one of the indoor air flowing from the upper interior and the ambient air flowing from the outside to be introduced into the main body 21 of the air conditioner unit 20.

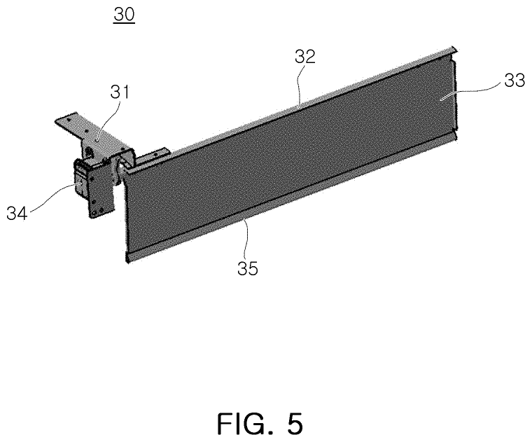

As illustrated in more detail in FIG. 5, the damper 30 includes a mounting bracket 31 coupled to the main body 21, a door 33 rotatably installed on the mounting bracket 31 via a door shaft 32, and an actuator 34 installed on the mounting bracket 31 and connected to the door shaft 32 to transmit rotational driving force to a door 33.

The mounting bracket 31 may be fixedly coupled to an internal surface of the upper stage 40 of the main body 21 by, for example, bolting or welding.

The door 33 may be an overall plate-shaped member, and may have one side edge provided with the door shaft 32 and the other side edge provided with an elastic sealing material 35.

The door shaft 32 may be connected to the actuator 34 to rotate, which allows the door 33 to be rotatable. Accordingly, one of the first suction port 41 and the second suction port 42 may be selectively opened or closed.

In addition, with the sealing material 35 provided on the door 33, sealing may be maintained to prevent the indoor air flowing from the interior through the first suction port 41 and the ambient air flowing from the outside of the vehicle 1 through the second suction port 42 from being mixed with each other.

A forwardly and reversely rotatable motor may be employed as the actuator 34, but examples of the actuator 34 are not limited thereto. For example, any actuator such as a hydraulic cylinder, an electric actuator, or the like, may be employed as the actuator 34 as long as it may rotate a door.

When only the indoor air in the upper interior needs to be circulated, for example, in the indoor air mode, as illustrated in FIG. 6, in the above-configured damper 30, the door 33 may be rotated by allowing the door shaft 32 to be rotated by the actuator 34. Accordingly, by the door 33, the second suction port 42 disposed on one side of the upper surface of the upper stage 40 of the body 21 may be closed and the first suction port 41 disposed in the front surface of the upper stage 40 of the body 21 may be opened, so that only the indoor air is circulated by natural convection while preventing the ambient air from being introduced into the air conditioner unit 20 and the interior.

Alternatively, when operating the blower 24 of the air conditioner unit 20 and the first compressor 51 while closing the second suction port 42 and opening the first suction port 41 by the door 33, for example, when cooling is performed without mixture of the ambient air, the indoor air cooled by the evaporator 23 of the air conditioning unit 20 may be supplied to the upper interior of the vehicle 1, and may then be introduced again into the air conditioning unit 20 to be circulated after being cooled. Therefore, cooling efficiency of the upper interior may be improved.

When at least the upper interior needs to be ventilated by introducing ambient air into the interior of the vehicle 1, for example, in the outdoor air mode, as illustrated in FIG. 7, the door 33 may be rotated by allowing the door shaft 32 to be rotated by the actuator 34. Accordingly, by the door 33, the first suction port 41 disposed in the front surface of the upper stage 40 of the main body 21 may be closed and the second suction 42 disposed on one side of the upper surface of the upper stage 40 of the main body 21 may be opened, and, at the same time, the blower 24 of the air conditioner unit 20 may operate, so that the ambient air introduced into the air conditioning room 7 through the introduction grill 10 may be forcibly introduced into the air conditioner unit 20 and the upper interior while preventing the indoor air from being introduced into the air conditioner unit 20.

In addition, when the first compressor 51 operates together with the blower 24 of the air conditioner unit 20 while closing the first suction port 41 and opening the second suction port 42 by the door 33, the ambient air cooled by the evaporator 23 of the air conditioner unit 20 may be supplied to the upper interior of the vehicle 1, and thus, ventilation and cooling of the upper interior may be simultaneously performed.

Moreover, since the first suction port 41 is closed by the door 33 in the outdoor air mode, the indoor air cannot be introduced into the air conditioner unit 20 through the internal circulation grill 18 of the partition member 8 and may be introduced into the air conditioning room 7, in which sound pressure is maintained according to the operation of the blower 24, through the internal exhaust grills 19 on opposite sides of the partition member, and may then be discharged to the outside of the vehicle having a two-story structure through the discharge grill 11 of the vehicle 1.

In other words, the air conditioning apparatus for a vehicle according to an example embodiment may forcibly suction fresh ambient air using the blower 24 of the air conditioner unit 20, and may blow the suctioned ambient air to the duct in the upper interior, as represented by arrows of FIG. 2 illustrating an air flow. In addition, the air conditioning apparatus for a vehicle may prevent stuffy indoor air of the upper interior from being circulated by the damper 30, and may discharge the stuffy indoor air to the outside of the vehicle 1 through the discharge grill 11 after sending the stuffy indoor air to the air conditioning room 7 through the internal exhaust grill 19.

Accordingly, the air conditioning apparatus for a vehicle according to an example embodiment may implement forced ventilation using the blower 24 of the air conditioner unit 20.

In the air conditioning apparatus for a vehicle according to an example embodiment, forced ventilation, for example, an outdoor air mode may be implemented by automatic control.

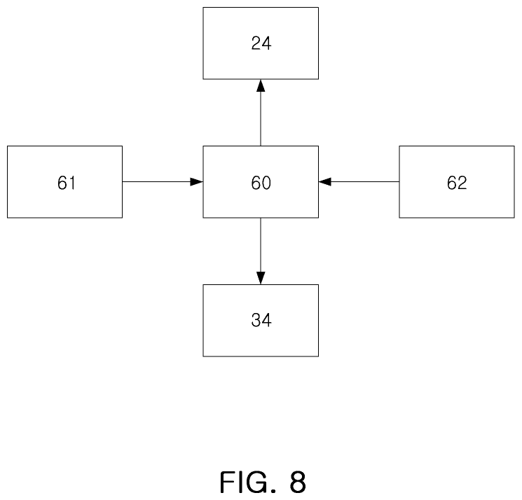

As illustrated in FIG. 8, the air conditioning apparatus for a vehicle according to an example embodiment may further include a concentration sensor 61, installed in the upper interior or the air conditioner unit 20 to detect a concentration of pollutants in the indoor air, and a control unit 60 selectively controlling operations of the damper 30 and the blower 24 according to a detection signal input from the concentration sensor 61.

The concentration sensor 61 may be installed, for example, in the vicinity of the upper deck 5 in the upper interior of the vehicle 1 or the first suction port 41 of the air conditioner unit 20. Such a concentration sensor may detect a concentration of pollutants such as carbon dioxide. The pollutants maybe present as particulate or gaseous materials, and may also include fine dust of which particles have significantly small sizes.

The control unit 60 may be implemented as various processing devices such as a microprocessor, in which semiconductor chips performing various operations or executing various commands are embedded, and may control the overall operation of the air conditioning apparatus for a vehicle according to an example embodiment.

For example, the control unit 60 may be integrated into an electronic control unit (ECU) of the vehicle 1 or maybe used in combination therewith.

For example, the control unit 60 may be electrically connected to the concentration sensor 61. The control unit 60 may determine a state of air in the upper interior based on a concentration of pollutants measured from the concentration sensor 61, and may execute the outdoor air mode for forced ventilation based on a result of the determination.

For example, when a concentration of carbon dioxide in the upper interior is 2,000 ppm or more, the actuator 34 of the damper 30 may operate under the control of the control unit 60, so that the first suction port 41 may be closed by the door 33 and the second suction port 42 may be opened by the door 33.

At the same time, the blower 24 of the air conditioner unit 20 may be operated by the control unit 60, so that fresh ambient air may be forcibly suctioned and may be blown to the duct in the upper interior, and stuffy indoor air in the upper interior may be prevented from being circulated by the damper 30 and may be discharged to the outside of the vehicle 1 through the internal exhaust grill 19, the air conditioning room 7, and the exhaust grill 11.

Then, when the concentration of carbon dioxide in the upper interior is decreased to 1,700 ppm or less, the actuator 34 of the damper 30 may operate under the control of the control unit 60, so that the second suction port 42 may be closed by the door 33 and the first suction port 41 may be opened by the door 33 to be switched into the indoor air mode.

In this case, the operation of the blower 24 of the air conditioner unit 20 is stopped, or the operation thereof may be maintained together with the first compressor 51 when cooling is performed.

On the other hand, in the air conditioning apparatus for a vehicle according to an example embodiment, forced ventilation, for example, an outdoor air mode may be implemented by driver's manual control.

For example, an input unit 62 may be electrically connected to the control unit 60. The input unit 62 may receive a corresponding input signal based on driver's manipulation, motion, or voice, and the control unit 60 may execute the outdoor air mode by manual control in corresponding to the input signal.

The input unit 62 may be implemented as, for example, a scroll wheel, a button, a knob, a touchscreen, a touchpad, a lever, a trackball, or the like, which may be manipulated by the driver. Alternatively, the input unit 62 may be implemented as at least one of a motion recognition sensor or a voice recognition sensor, which detects driver's motion or voice, or a combination thereof.

Accordingly, when the driver selects the outdoor air mode through the input unit 62, for example, the control unit 60 may operate the actuator 34 of the damper 30 such that the first suction port 41 is closed by the door 33 and the second suction port 42 is opened by the door 33, and, at the same time, may operate the blower 24 of the air conditioner unit 20.

Thus, fresh ambient air may be forcibly suctioned and blown to the duct in the upper interior, and the stuffy indoor air in the upper interior may be prevented from being circulated by the damper 30 and discharged to the outside of the vehicle 1 through the internal exhaust grill 19, the air conditioning room 7, and the discharge grill 11.

As described above, according to the air condition apparatus for a vehicle according to an example embodiment, forced ventilation using a blower of an air conditioner unit may be implemented. Thus, ambient air may be automatically introduced into an upper interior and ventilation timing may be controlled by automatic control or a driver to improve cooling efficiency of the upper interior.

While exemplary embodiments have been shown and described above, it will be apparent to those skilled in the art that modifications and variations could be made without departing from the scope of the present disclosure as defined by the appended claims.

What is claimed is:

1. An air conditioning apparatus for a vehicle, comprising:
an air conditioner unit to be disposed in an air conditioning room of a vehicle, the air conditioner unit including a blower to suction and blow ambient air to an interior of the vehicle, wherein the ambient air is air that is introduced into the air conditioning room from an outside of the vehicle;
a damper installed in an opening on an introduction side of the air conditioner unit to selectively allow introduction of one of indoor air flowing from the interior and the ambient air; and
an internal exhaust grill to be installed in the interior to fluidly communicate with a space defined by the air conditioner unit and an internal side surface of the air conditioning room,
wherein the indoor air is to be discharged to an outside of the vehicle through the internal exhaust grill and the air conditioning room.

2. The air conditioning apparatus of claim 1, further comprising:
an introduction grill in a body shell of the vehicle to allow an inside of the air conditioning room and the ambient air to fluidly communicate with each other; and
a discharge grill spaced apart from the introduction grill in the body shell to allow the inside of the air conditioning room and the ambient air to fluidly communicate with each other.

3. The air conditioning apparatus of claim 2, wherein the air conditioning room comprises:
a partition member to connect opposite internal walls of the interior, the partition member having: (i) one side edge to connect to a rear end portion of a deck of the vehicle, and (ii) at least one internal circulation grill and the internal exhaust grill installed in the partition member, the at least one internal circulation grill and the internal exhaust are adjacent to opposite ends of the partition member; and
an upper panel to connect the other side edge of the partition member and a rear surface of the body shell to each other.

4. The air conditioning apparatus of claim 3, wherein the at least one internal circulation grill and the internal exhaust grill are to be exposed to the interior below a rearmost seat placed on the deck.

5. The air conditioning apparatus of claim 3, wherein the air conditioner unit further includes a main body including an upper stage in a form of a duct and a lower stage in a form of a frame, and
the damper is disposed in the upper stage.

6. The air conditioning apparatus of claim 5, further comprising a guide duct and at least one exhaust port,
wherein the at least one exhaust port is to be opened toward the air conditioning room and is in an upper surface of the upper stage,
the at least one exhaust port is to be connected to the guide duct, and
the guide duct is to be connected to a duct in the interior.

7. The air conditioning apparatus of claim 5, further comprising a dust collecting filter, an evaporator, a compressor, and a condenser module for a refrigerant of the evaporator,
wherein the dust collecting filter, the evaporator, and the blower are sequentially disposed from a front surface in the upper stage, and
the compressor and the condenser module are mounted in the lower stage.

8. The air conditioning apparatus of claim 3, wherein the air conditioner unit further includes a main body including an upper stage in a form of a duct and a lower stage in a form of a frame, and
wherein the upper stage comprises:
at least one first suction port on a front surface of an upper stage and fluidly communicating with the at least one internal circulation grill to introduce the indoor air from the interior thereinto; and
at least one second suction port in an upper surface of the upper stage to introduce ambient air thereinto, and
wherein the damper is installed between the first suction port and the second suction port.

9. The air conditioning apparatus of claim 8, wherein the damper comprises:
a mounting bracket coupled to the main body;
a door rotatably installed on the mounting bracket via a door shaft; and
an actuator installed on the mounting bracket and connected to the door shaft to transmit rotational driving force to the door.

10. The air conditioning apparatus of claim 9, further comprising:
a concentration sensor installed in the interior or the air conditioner unit to detect a concentration of pollutants in the indoor air; and
a control unit configured to selectively control operations of the damper and the blower according to a detection signal input from the concentration sensor.

11. The air conditioning apparatus of claim 10, further comprising:
an input unit electrically connected to the control unit,
wherein the input unit receives an input signal based on driver's manipulation, motion, or voice.

12. The air conditioning apparatus of claim 9, wherein when in an outdoor air mode, the door shaft is to be rotated by the actuator to rotate the door, and
the first suction port is to be closed by the door and the second suction port is to be opened by the door and, at the same time, the blower is to operate such that the ambient air is forcibly introduced into the air conditioner unit and the interior.

13. The air conditioning apparatus of claim 9, wherein when in an indoor mode, the door shaft is to be rotated by the actuator to rotate the door, and
the second suction port is to be closed by the door and the first suction port is to be opened by the door, and the indoor air is to be introduced into the air conditioner unit through the at least one internal circulation grill.

14. A method comprising:
ventilating the interior of the vehicle via the air conditioning apparatus of claim 1.

15. The method of claim 14, wherein the vehicle has a two-story structure.
